(19) United States
(12) Patent Application Publication
(10) Pub. No.: US 2007/0119101 A1
(43) Pub. Date: May 31, 2007

(54) INTERNAL REINFORCEMENT STRUCTURE FOR AUTOMOTIVE VEHICLE DOOR PANELS

(75) Inventor: Ingemar Mattsson, Morrum (SE)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/164,566

(22) Filed: Nov. 29, 2005

(51) Int. Cl. E05F 11/38

(52) U.S. Cl. 49/502

(57) ABSTRACT

A vehicle door assembly structural reinforcement is disclosed. Glass supporting channels are disposed between inner and outer door panel assemblies. A belt reinforcement member is part of the outer door panel assembly. Connector brackets connect the belt reinforcement member to the inner door panel assembly to reduce the effective span between end supports for the belt reinforcement member, thereby enhancing the stiffness of the belt reinforcement member and the door assembly.

### BACKGROUND OF THE INVENTION

1. Field of the Invention

The invention relates to automotive vehicle door panel constructions in which an outer door panel assembly is characterized by enhanced structural stiffness.

2. Background Art

A vehicle door construction for contemporary automotive vehicles typically comprises a plurality of structural panels. Window glass channels secure a glass window pane at forward and rearward edges of the window pane while accommodating movement of the window glass between a closed position and an open position. A door outer structure is disposed on one side of the window glass and a door inner structure is disposed on the opposite side. The door outer structure typically includes a belt reinforcement that extends fore and aft from a forward door opening location to a rearward door opening location. The belt reinforcement typically is situated proximate to the outer side of the window glass and the window glass supporting glass channels. The door outer structure includes also an outer panel situated on the outboard side of the belt reinforcement.

The span between the front end and the rear end of the side door outer structure typically has no transverse support for transmitting loads from the belt reinforcement into the stiffer inner door structure on the inside of the window area. The outer door structure span is approximately equal to the width of the vehicle door opening. Because of its relatively long span, the side door outer structure typically is characterized by low stiffness since stiffness is inversely proportional to the length of the span between end supports.

Prior art vehicle door constructions do not permit a practical way to compensate for the low stiffness of the side door outer structure because of a lack of space between the side door outer structure and the window glass support channels.

Because of the low stiffness of the vehicle side door outer structure, which includes the outer panel and the belt reinforcement, access to the interior of the vehicle during burglaries can be accomplished by deflecting the side door outer structure using special tools for forcing the side door outer structure outwardly relative to the inner side door structure. This creates a space that allows an intruder to activate and release a door locking mechanism situated in the interior of the door between the side door inner structure and side door outer structure.

### SUMMARY OF THE INVENTION

It is an objective of the invention to reduce the vulnerability of a contemporary vehicle side door to unlawful entry by reducing the span between belt reinforcement securements at the forward portion and the rearward portion of the belt reinforcement, thereby increasing the stiffness of the side door outer structure. The securements are relatively close to the forward and rearward edges of the window glass.

The securements for the belt reinforcement comprise at least one connector bracket that engages the belt reinforcement and a glass channel, one glass channel being located at the forward edge of the window glass and another glass channel being located adjacent the rearward edge of the window glass.

If two connector brackets are used, one end of each connector bracket is fixed permanently to an adjacent glass channel. This may be done by spot welding or riveting. The other end of each glass channel is located near one of the mechanical securements to the belt reinforcement.

A mechanical connection between each connector bracket and the belt reinforcement may be a screw or a similar mechanical fastener, which may be released when there is a need for replacing an original equipment manufacturer's (OEM) outer panel and belt reinforcement subassembly. Access to this mechanical fastener is made by providing a tool access opening in each of the side door inner structural panels. Thus, the fastener can be applied and released using a suitable tool that may be inserted through the openings.

During assembly of the door structure, the side window glass, in the initial assembly steps, will not have been assembled in place. It is possible, therefore, to access the fastener with a suitable tool. The access will not be prevented by the window glass, which is assembled in the vehicle side door construction in a later step in the assembly process.

In accordance with one feature of the invention, the connector bracket may be a symmetrical part so that it can be located on both the leading edge of the door opening and the rear edge of the door opening.

### BRIEF DESCRIPTION OF THE DRAWINGS

FIG. 1 is an isometric plan view of an automotive vehicle side door;

FIG. 2 is a partial plan view of a portion of the door of FIG. 1 in proximity to the forward edge of the door opening with the side door outer structure removed;

FIG. 3 is a partial plan view of a forward portion of the inner door panel structure;

FIG. 4 is a partial plan view of a rear portion of the inner door panel structure;

FIG. 5 is a partial cross-sectional view of the door structure seen in FIG. 1 as viewed from the plane of section line 5-5 of FIG. 1;

FIG. 6 is an enlarged cross-sectional view of the front portion of the door structure seen in FIG. 5;

FIG. 7 is a partial enlarged cross-sectional view of the rearward portion of the view of FIG. 5; and

FIG. 8 is a detailed schematic illustration of a connector bracket located at a forward location of the door structure as seen in the cross-sectional view of FIG. 5.

### PARTICULAR DESCRIPTION OF AN EMBODIMENT OF THE INVENTION

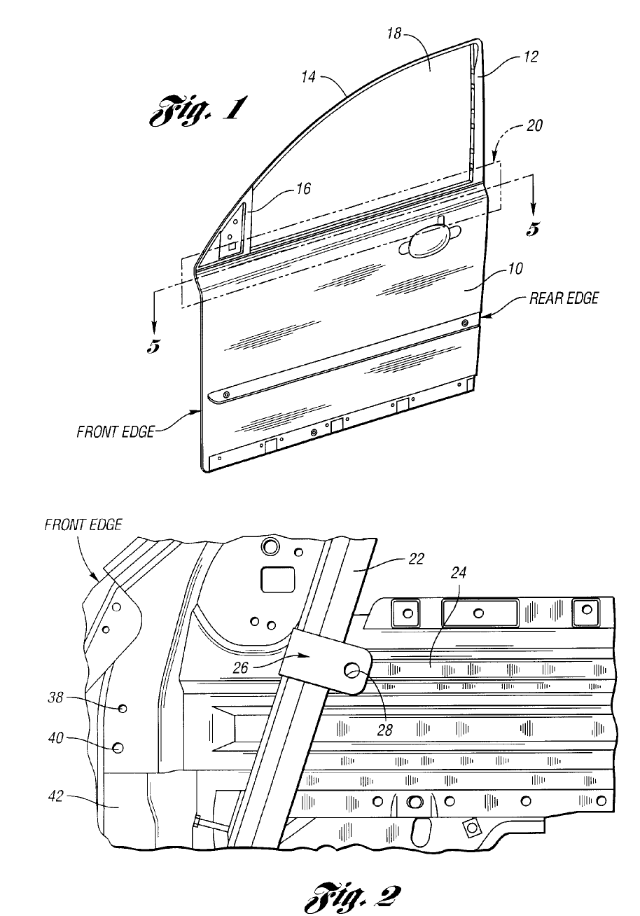

FIG. 1 is an isometric plan view of a front left side door outer panel assembly, including an appropriately contoured outer door panel 10, a rear portion 12, an upper portion 14 and a forward portion near front window frame portion 16. The side window glass is indicated at 18.

The complete side door outer structure is not illustrated in FIG. 1. The side door inner structure also is lacking. The area of interest, for purposes of the subsequent description of the invention, is indicated in FIG. 1 by the area enclosed by dotted lines, as shown at 20.

FIG. 2 shows the side door inner structure as viewed from the exterior of the vehicle with the outer side door structure removed. A window glass channel 22 is secured to the outboard surface of panel 24, which forms a part of the side door inner structure. A structural connection between the glass channel 22 and the panel 24 can be formed by welding, although other fastening techniques could be used, including riveting.

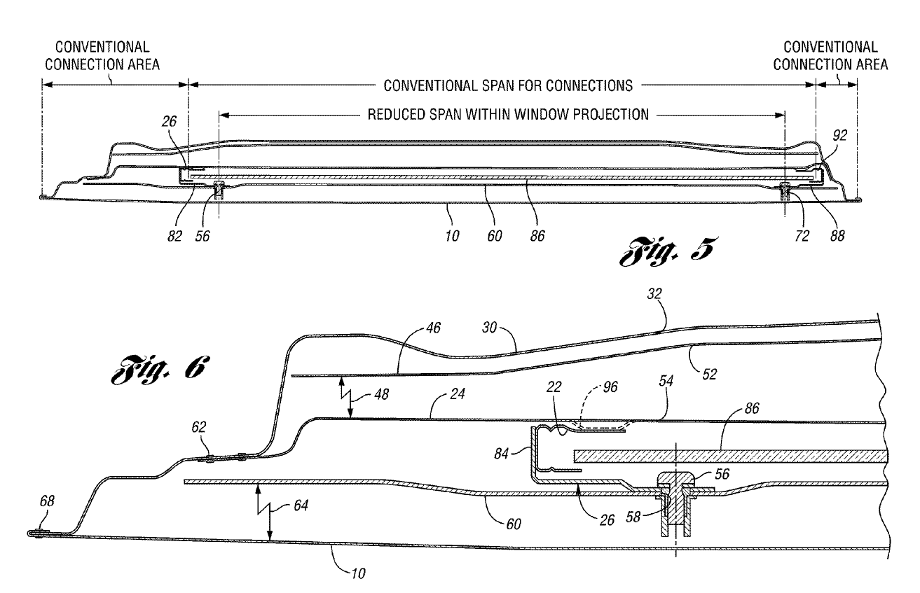

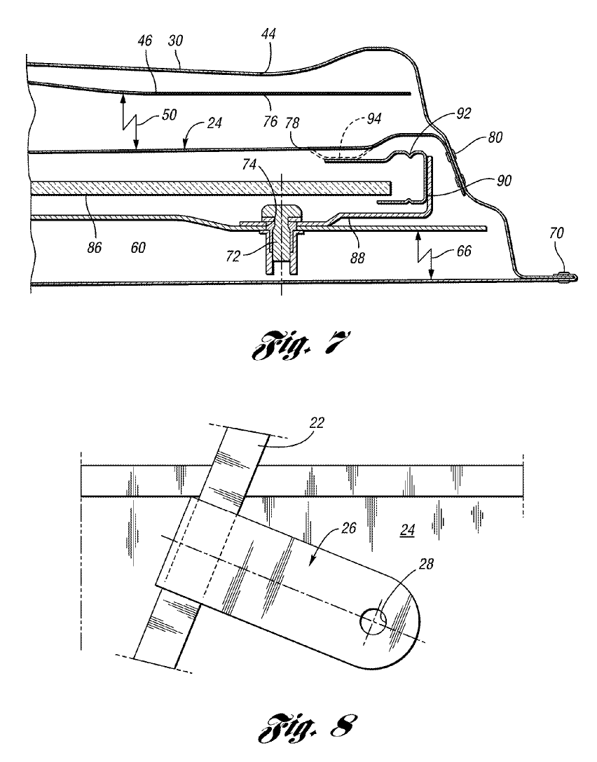

As will be described subsequently with reference to FIGS. 5 and 6, the glass channel 22 has a U-shaped cross section. It provides a support for the front edge of the window glass 18, as the window glass is raised and lowered between the side door inner structure and the side door outer structure. A connector bracket, which will be described more particularly with reference to FIG. 6, is shown in FIG. 2 at 26. The bracket 26 provides a secure mechanical connection between the glass channel 22 and the belt reinforcement, which forms a part of the side door outer structure as will be described with reference to FIGS. 6 and 7.

Bracket 26 includes an opening 28 for accommodating a fastener that mechanically connects the connector bracket 26 and the glass channel 22 to the side door outer structure.

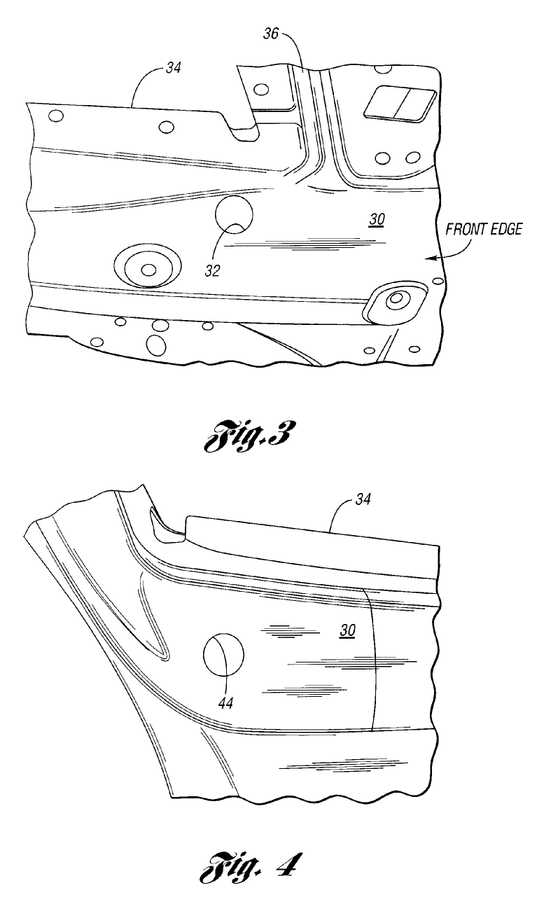

FIG. 3 is a partial plan view of the front edge portion of the side door inner structure, which includes an innermost panel 30 that may support a trim panel (not shown). Panel 30 is provided with an access opening 32, which is aligned with the opening 28 in the connector bracket 26 seen in FIG. 2. The panel 30 is provided with a window glass opening, which has a sill portion 34 and a front edge window glass frame portion shown at 36, which forms a part of the forward window frame 16 seen in FIG. 1.

As seen in FIG. 2, the panel 24 is secured preferably by spot welds, shown at 38 and 40, to the front edge of a structural door frame 42, which is hinged to the vehicle body structure.

FIG. 4 shows the rearward portion of the panel 30 adjacent the rearward edge of the window glass opening. A tool access opening 44 is formed in the rearward portion of the panel 30 to permit tool access to a fastener that will be described with reference to FIG. 7. Intermediate side door inner structure panel 46, seen in FIG. 6, is situated between the inner panel 30 and the panel 24 of the side door inner structure. Panel 46 is connected by welding or other fastening techniques to the panel 24, as indicated schematically at 48 in FIG. 6 and at 50 in FIG. 7.

A tool access opening 52 is formed in the panel 46 and a tool access opening 54 is formed in the panel 24, as indicated in FIG. 6. The access openings 32, 52 and 54 are aligned with a fastener, such as a threaded fastener 56.

Fastener 56 is received in an opening 58 formed in reinforcement member 60, which extends longitudinally fore-and-aft in the space between outer panel 10 and panel 24 of the side door inner structure.

The outer panel 10 is welded at its margin to the forward edge region of the inner panel 30, as shown at 62 in FIG. 6. Reinforcement member 60 is secured permanently, such as by welding, to the outer panel 10, as schematically illustrated at 64 in FIG. 6 and at 66 in FIG. 7. The inner panel 30 is secured at its forward margin to the outer panel 10 by welding, as shown at 68 in FIG. 6 and at 70 in FIG. 7.

The rearward region of the door panels seen in FIG. 7 includes a second fastener, such as a threaded fastener 72, received in an opening 74 in the rearward portion of the reinforcement member 60. The threaded fastener 72 is aligned with opening 44 in inner panel 30, with opening 76 at the rearward region of inner panel 46 and with an access opening 78 in the rearward portion of inner panel 24. The rearward portion of panel 24 is secured by welding at its margin to the inner panel 30, as seen at 80.

The reinforcement member 60 extends through the door structure from the forward edge to the rearward edge in the general region of interest, indicated at 20 in FIG. 1. Connector bracket 26, which is generally of L-shape, has a leg with an opening 28 through which the threaded fastener 56 extends, as seen in FIG. 6. A tool can be inserted through the access openings 32, 52 and 54 from the inner side of the side door inner structure to secure the bracket 26 in place. A second leg of the bracket 26 extends in a generally perpendicular direction with respect to the adjacent leg. It is secured at 84 to a side of the window glass U-shaped channel 22. The U-shaped channel, as mentioned previously, is secured to the panel 24 of the side door inner structure. Therefore, the reinforcement member 60 is firmly secured to the inner door structure to form a robust and stiff door assembly.

The window glass 86 has its forward margin received in the window glass channel at 26. During the assembly procedure, however, the glass 86 is not in place. Therefore, the fastener 56 can be accessed to secure the connector bracket 26 to the glass channel 22.

At the rearward edge of the side door inner structure, a second connector bracket of generally L-shape is provided, as shown at 88. It has an opening for receiving a fastener 72, whereby the fastener 72 secures the bracket 88 to the panel 60. Right angle portion 90 of the bracket 88 is secured to one side of a rearwardly positioned glass channel of U-shape, as shown at 92. The glass channel 92 is secured to the panel 24, as schematically shown at 94. That connection is located out of the plane of the cross section line 5-5 seen in FIG. 1.

The glass channel 26 is secured to the panel 24 at the forward edge region of the side door inner structure, as shown schematically at 96 in FIG. 6. Thus, the connector bracket 88 complements the stabilizing characteristic of the connector bracket 26 to provide a stable, robust connection between reinforcement member 60 and the inner door structure at both the forward edge region and the rear edge region of the side door assembly.

FIG. 5 illustrates a reduction in the effective span between the supports for the reinforcement member for the construction of the present invention in comparison to a conventional span for a vehicle side door structure. The reduced span within the window projection of the inner structure of the present invention is substantially less than the conventional span, as indicated in FIG. 5. This increases the stiffness of the door assembly and reduces the deflection of the reinforcement member 60 from the plane of the glass 86 when a force is applied to the reinforcement member, thereby making it much more difficult for an intruder to gain access to the vehicle interior.

The best span between the fasteners 56 and 72 is computed as follows:

δ=Fl³[X]EI, where

δ=deflection that should be minimized;

F=force in a direction perpendicular to the plane of the window glass;

l=the length of the span between the fasteners 56 and 72;

E=the modulus of elasticity of the reinforcement member; and

I=the second moment of inertia.

The term “X” is a load case factor for free end supports for a beam. The value for “X” is empirically determined depending upon how the beam is supported and the load is applied. It is obtained using a stimulated computer model using a free body loading of an end supported beam.

Although an embodiment of the invention has been disclosed, it will be apparent to a person skilled in the art that modifications may be made without departing from the scope of the invention. All such modifications and equivalents thereof are intended to be included within the scope of the following claims.

What is claimed is:

1. A door assembly for an automotive vehicle comprising:
a door outer panel extending from a forward edge portion of a vehicle door opening to a rearward vehicle door opening edge portion;
a door inner structural panel assembly;
a belt reinforcement member between the outer panel and the inner structural panel assembly and extending from the forward edge portion to the rearward edge portion;
first and second window glass supporting channels between the belt reinforcement member and the door inner structural panel assembly, the glass supporting channels being fixed to the door inner panel assembly; and
at least one connecting bracket mechanically connecting the belt reinforcement member to the inner structural panel assembly whereby the door assembly stiffness is enhanced.

2. A door assembly for an automotive vehicle comprising:
a door outer panel extending from a forward edge portion of a vehicle door opening to a rearward vehicle door opening edge portion;
a door inner structural panel assembly;
a belt reinforcement member between the outer panel and the inner structural panel assembly and extending from the forward edge portion to the rearward edge portion;
first and second window glass supporting channels between the belt reinforcement member and the door inner structural panel assembly, the glass supporting channels being fixed to the door inner structural panel assembly;
a first connecting bracket mechanically connecting the belt reinforcement member and the inner structural panel assembly within a glass window glass projection area in proximity to a forward edge of a window glass in the glass supporting channels;
a second connecting bracket mechanically connecting the belt reinforcement member and the inner structural panel assembly within a window glass projection area in proximity to a rearward edge of a window glass in the glass supporting channel.

3. The door assembly set forth in claim 1 wherein the connecting bracket comprises a first portion secured to the belt reinforcement member at a securement location within the projection area of a window glass and a second portion secured to the first window glass supporting channel at a location forward of the securement location.

4. The door assembly set forth in claim 3 wherein a second connecting bracket mechanically connects the belt reinforcement member and the inner structural panel assembled within the glass projection area in proximity to a rearward edge of a window glass in the glass supporting channels.

5. The door assembly set forth in claim 1 wherein the door inner structural panel assembly comprises first inner panel and a second inner panel, the second inner panel being disposed between the first inner panel and the glass channels, the connecting bracket being mechanically connected to the second inner panel.

6. The door assembly set forth in claim 2 wherein the door inner structural panel assembly comprises a first inner panel and a second inner panel, the second inner panel being disposed between the first inner panel and the glass channels, the first and second each being mechanically connected to the second inner panel.

7. The door assembly set forth in claim 5 wherein the inner door panels of the inner structural panel assembly are secured together at respective forward and rearward panel margins, the belt reinforcement member extending between the forward and rearward panel margins;
a span between the forward and rearward margins being greater than a span between the mechanical connections between the belt reinforcement member and the first and second connecting brackets whereby the structural stiffness of the door assembly is enhanced.

8. The door assembly set forth in claim 5, including a door outer panel, the belt reinforcement member being disposed between the second inner panel and the door outer panel, the belt reinforcement member and the outer panel forming a door outer structural panel assembly.

9. The door assembly set forth in claim 7 wherein a functional relationship between the span between the mechanical connection and deflection due to a force applied to the belt reinforcement is expressed as
δ=Fl³[X]EI, where
δ=deflection to be minimized,
F=force,
l=length of span between end supports,
E=modulus of elasticity,
I=2^{nd} moment of inertia, and
X=load case factor.

10. The door assembly set forth in claim 1 wherein the mechanical connection of the belt reinforcement member to the inner structural panel assembly includes a releasable fastener, the inner structural panel assembly including at least one access opening to permit entry of a tool to attach and release the fastener.

11. The door assembly set forth in claim 2 wherein the mechanical connection of each connection bracket with the inner structural panel assembly comprises a releasable fastener, the inner structural panel assembly having access openings to permit entry of a tool to attach and release the fastener.
